(19) United States
(12) Patent Application Publication
(10) Pub. No.: US 2007/0153073 A1
(43) Pub. Date: Jul. 5, 2007

(54) PAD MOUNTING FOR A PAD PRINTER

(76) Inventors: TRACY KUCABA, South Elgin, IL (US); DANA PULVINO, Crystal Lake, IL (US)

Correspondence Address: CARDINAL LAW GROUP, Suite 2000, 1603 Orrington Avenue, Evanston, IL, 60201, US

(21) Appl. No.: 11/617,092

(22) Filed: Dec. 28, 2006

Related U.S. Application Data
(60) Provisional application No. 60/754,719, filed on Dec. 29, 2005.

(51) Int. Cl. B41J 2/01

(52) U.S. Cl. 347/101

(57) ABSTRACT

Pad mounting for a pad printer including a pad printer having a frame; a pad coupler attached to the frame; a printing pad; and a locking mechanism. The locking mechanism removably secures the printing pad to the pad coupler.

### RELATED APPLICATIONS

This application claims the benefit of U.S. Provisional Patent Application 60/754,719 filed Dec. 29, 2005, the entirety of which is incorporated herein by reference.

### TECHNICAL FIELD OF THE INVENTION

The present invention relates generally to the printing process and in particular to mounting of a pad to a pad printer.

### BACKGROUND OF THE INVENTION

The pad printing process is an indirect intaglio process. Depressions representing the logo of choice are created on a flat surface called “the plate” or pad printing cliché. There are two types of cliché plates—variable depth relief photopolymer plates and fixed depth relief plates. The depressions for logos having multiple colors require multiple plates dedicated to each individual color of the image to be printed. A plate for each color in the image is etched with UV light, by way of a photoactive polymer and a film positive. After an initial exposure period, the logo and plate are completely covered with a screen film and exposed to UV light again (“screening”); this step is necessary for variable depth relief photopolymer plates, but is not necessary for fixed depth relief plates. Screening is a process that places many small “dots,” in the shape of truncated cones, into the surface of the etched image itself.

The pad printing process begins by spreading ink across the surface of the plate. Excess ink is then scraped back into an ink reservoir using a “doctor blade” which leaves ink only in the depressions on the plate. As the plate is exposed to air, thinner evaporates from the ink remaining in the depressions causing the ink surface to become tacky. A pad, which is a smooth, resilient, stamp block of a deformable material, such as silicone rubber, is used to lift ink from the plate and transfer it to the surface to be printed. Pad printing is used to apply high quality print on flat as well as non-flat and irregular surfaces. For example, pad printing can be used to print logos and the like on cellular telephone covers, game balls, golf balls, and the like. Such printing can be carried out not only on a spherical surface, but on a surface that includes dimples as well.

The printing pad is part of a printing pad assembly, which includes the printing pad permanently affixed to a base, such as a rigid piece of wood or plastic. The printing pad assembly is mounted to the frame of the printer with a number of screws or bolts. The printing pad wears out with use and requires replacement to maintain the integrity of the printed image. Removal of the printing pad assembly is a difficult and time-consuming process. Printing time is lost since the printing process must be shut down to replace the printing pad assembly.

The two part printing pad assembly also increases waste and cost. The replacement of the printing pad assembly replaces both the printing pad, which is worn and needs replacement, and the base, which is not subject to wear and does not need replacement, so the base is disposed of unnecessarily. The printing pad assembly is costly, because the two different parts must be manufactured separately and permanently joined together. This requires a great deal of manufacturing time due to the complexity of joining the different parts.

Therefore, it would be desirable to have pad mounting for a pad printer that overcomes the above disadvantages.

### SUMMARY OF THE INVENTION

One aspect of the present invention provides a pad printer including a frame; a pad coupler attached to the frame; a printing pad; and a locking mechanism. The locking mechanism removably secures the printing pad to the pad coupler.

Another aspect of the present invention provides a mounting method including providing a frame having a pad coupler; providing a printing pad; and removably securing the printing pad to the pad coupler.

Another aspect of the present invention provides a mounting system including a frame having a pad coupler; a printing pad; and means for removably securing the printing pad to the pad coupler.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 is a side view of a pad printer in accordance with one embodiment of the present invention;

FIG. 2 is a cross-sectional view of a pad coupler removably secured to a printing pad illustrating a C-clip locking mechanism, in accordance with one embodiment of the present invention;

FIG. 3 is a cross-sectional view of a pad coupler removably secured to a printing pad illustrating a pin locking mechanism, in accordance with one embodiment of the present invention;

FIG. 4 is a cross-sectional view of a pad coupler removably secured to a printing pad illustrating a dovetail interface, in accordance with one embodiment of the present invention;

FIG. 5 is a cross-sectional view of a pad coupler removably secured to a printing pad illustrating a flange interface, in accordance with one embodiment of the present invention;

FIG. 6 is a cross-sectional view of a pad coupler removably secured to a printing pad illustrating a magnetic interface, in accordance with one embodiment of the present invention; and

FIG. 7 is a cross-sectional view of a pad coupler removably secured to a printing pad illustrating a magnetic interface, in accordance with one embodiment of the present invention.

### DETAILED DESCRIPTION OF THE PRESENTLY PREFERRED EMBODIMENTS

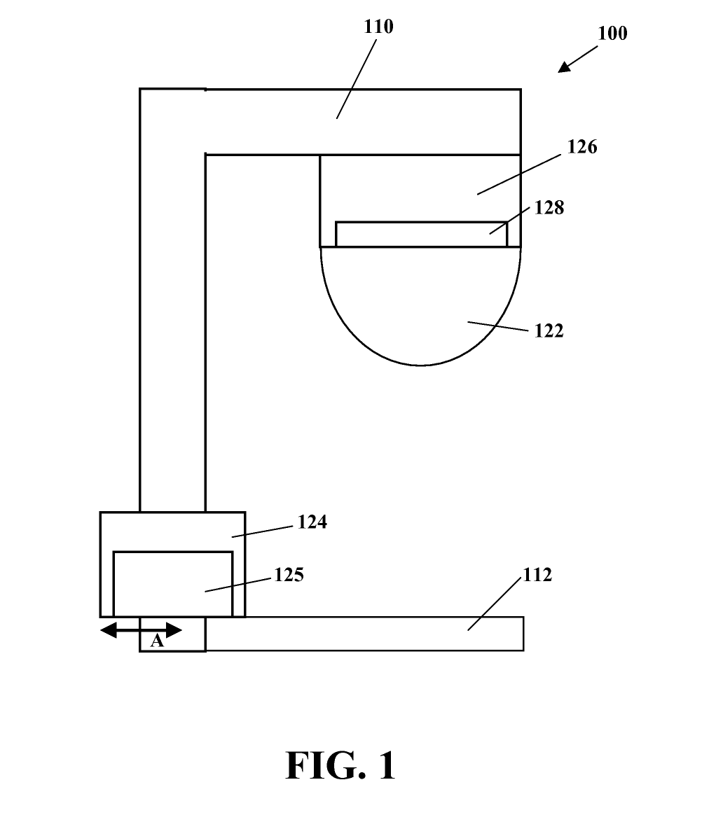

FIG. 1 is a side view of a pad printer in accordance with one embodiment of the present invention, shown generally by numeral 100. The printer 100 includes a frame 110, a pad coupler 126 attached to the frame 110, a printing pad 122, and a locking mechanism 128. The locking mechanism 128 removably secures the printing pad 122 to the pad coupler 126. Those skilled in the art will recognize that the printer 100 can vary as desired for a particular application and is not limited to the configurations of the description and illustrations provided herein.

In one embodiment, the printing pad 122 reciprocates into contact with the cliché plate 112, which is operably attached to the frame 110. The printer 100 includes a motor (not shown) for powering the reciprocation of the printing pad 122. Cliché plate 112 and ink cup 124 also reciprocate from a loading position to a transfer position relative to one another (as indicated by arrow A) to supply ink to the cliché plate 112. Ink cup 124 includes a reservoir body 125 with an open lower end and a doctor blade or knife ring around the open end. The doctor blade maintains intimate contact with the cliché plate 112 to form a seal for retaining the ink in the ink cup 124. The doctor blade also scrapes the surface of the cliché plate 112 to clean off excess ink as the cliché plate 112 is advanced from a loading position to a transfer position. The only substantial amount of ink retained on the cliché plate 112 is retained in the engraved or etched regions in the cliché plate 112 that define the print pattern. As such, a relatively clean image is produced on the printed surface.

The printing pad 122 can be any deformable pad onto which ink is transferred, and from which the ink is transferred to an object to be imprinted. An exemplary printing pad 122 is formed from a resilient, low permeability material such as silicone rubber or the like.

The locking mechanism 128 can be any configuration of the pad coupler 126 and the printing pad 122 that removably secures the printing pad 122 to the pad coupler 126. The locking mechanism 128 can include additional parts, such as pins, rings, and/or magnets, to assist in securing the printing pad 122 to the pad coupler 126, as long as the additional parts are readily removable to facilitate replacement of the printing pad 122.

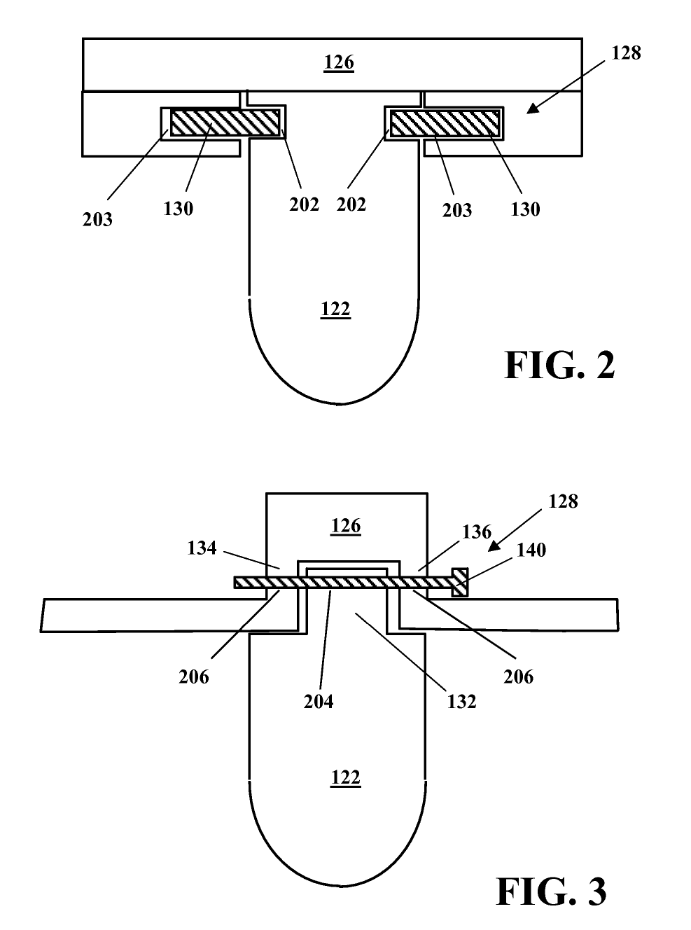

In a first embodiment, shown in FIGS. 2 and 3, the locking mechanism 128 is a keeper which removably secures the printing pad 122 to the pad coupler 126. The keeper is removably disposed in apertures in the printing pad 122 and the pad coupler 126.

FIG. 2 is a cross-sectional view of a pad coupler removably secured to a printing pad illustrating a C-clip locking mechanism, in accordance with one embodiment of the present invention. The locking mechanism 128 includes a locking ring 130 as the keeper positioned in an aperture 202 formed in the printing pad 122 and an aperture 203 formed in the pad coupler 126. Apertures 202 and 203 are shaped to correspond to the shape of the locking ring 130. Locking ring 130, for example, can be a C-shaped clip or clip of another shape. In one embodiment, the ring 130 provides an upward spring force for holding the printing pad 122 fast to the pad coupler 126.

FIG. 3 is a cross-sectional view of a pad coupler removably secured to a printing pad illustrating a pin locking mechanism, in accordance with one embodiment of the present invention. Printing pad 122 includes a pad flange portion 132, positioned between coupler flange portions 134, 136 of the pad coupler 126. The locking mechanism 128 is a pin 140 as the keeper positioned through an aperture 204 formed in the pad flange portion 132 of the printing pad 122 and an aperture 206 formed in the coupler flange portions 134, 136 of the pad coupler 126. The apertures 204 and 206 are shaped to correspond to the shape of the pin 140. Pin 140 can be smooth, threaded, ridged, or have other surface features as desired for a particular application.

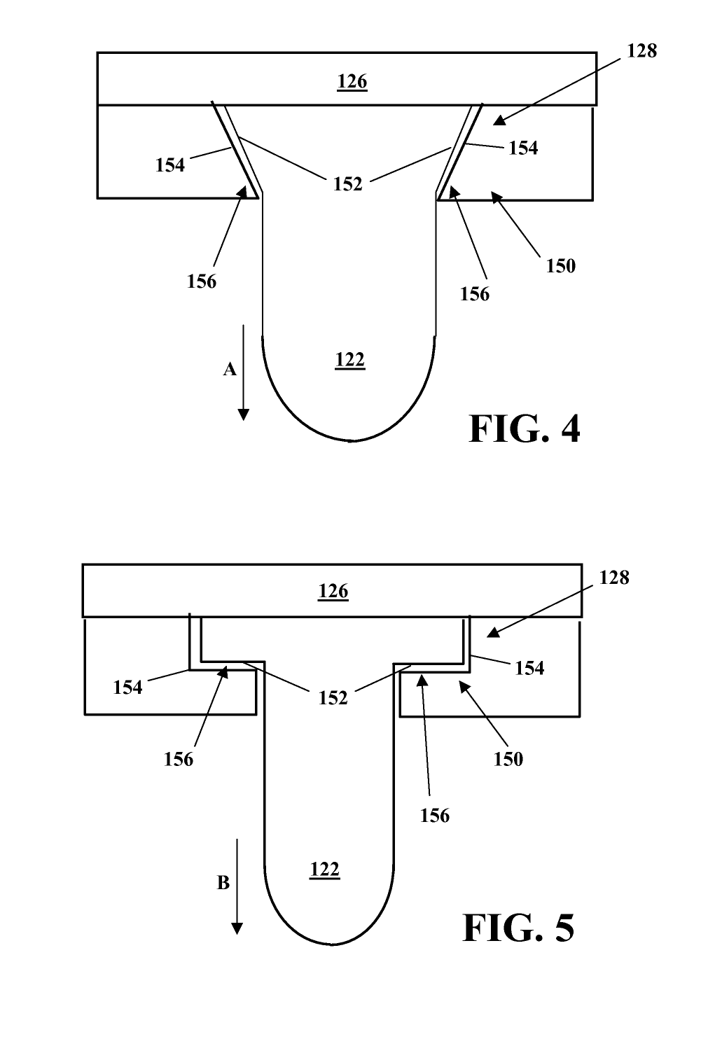

In a second embodiment, shown in FIGS. 4 and 5, the locking mechanism 128 is a pad interface 150 in a complementary configuration which removably secures the printing pad 122 to the pad coupler 126. Pad interfaces 150 include surfaces 152 of the printing pad 122 complementary to surfaces 154 of the pad coupler 126. Surfaces 152 of the printing pad 122 interlock with the surfaces 154 of the pad coupler. Those skilled in the art will appreciate that the pad interfaces 150 can be any shape restricting motion of the printing pad 122 away from the pad coupler 126 while allowing motion parallel to the face of the printing pad 122 to which the printing pad 122 is attached.

FIG. 4 is a cross-sectional view of a pad coupler removably secured to a printing pad illustrating a dovetail interface, in accordance with one embodiment of the present invention. In this example, the pad interface 150 includes two dovetail interfaces 156. Dovetail interface 156 includes surfaces at acute angles that prevent the printing pad 122 from removal in a downward direction (i.e., in a direction along arrow A). However, the printing pad 122 can be removed when necessary for replacement by sliding the printing pad 122 in a direction orthogonal to arrow A (i.e., out of the plane of the page of FIG. 4). In one embodiment, the dovetail interfaces 156 are milled in the block forming the pad coupler 126. In another embodiment, the dovetail interfaces 156 are formed separately and applied to form the pad coupler 126.

FIG. 5 is a cross-sectional view of a pad coupler removably secured to a printing pad illustrating a flange interface, in accordance with one embodiment of the present invention. In this case, the pad interfaces 150 include two flange interfaces 156. Flange interface 156 includes surfaces at approximately perpendicular angles that prevent the printing pad 122 from removal in a downward direction (i.e., in a direction along arrow B). However, the printing pad 122 can be removed when necessary for replacement by sliding the printing pad 122 in a direction orthogonal to arrow B (i.e., out of the plane of the page of FIG. 5). In one embodiment, the flange interfaces 156 are milled in the block forming the pad coupler 126. In another embodiment, the flange interfaces 156 are formed separately and applied to form the pad coupler 126.

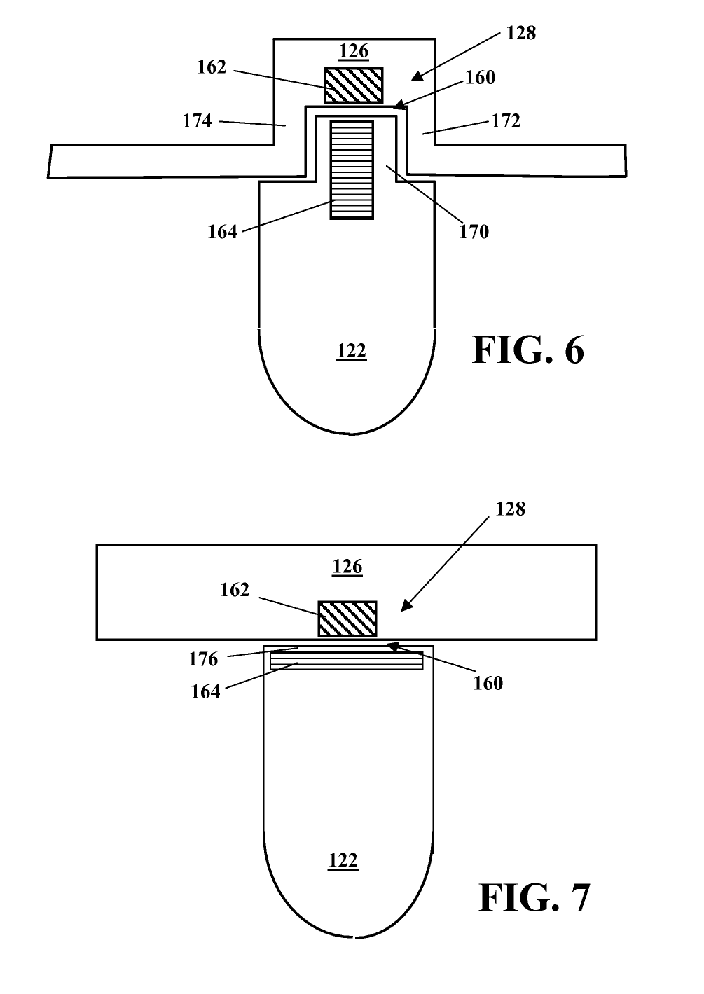

In a third embodiment, shown in FIGS. 6 and 7, the locking mechanism 128 is a magnetic interface 160 which removably secures the printing pad 122 to the pad coupler 126. Pad coupler 126 includes a first magnetic member 162 and the printing pad 122 includes a second magnetic member 164. The first and second magnetic members 162, 164 are magnetically attractive. Those skilled in the art will appreciate that the first and second magnetic members 162, 164 are interchangeable, i.e., the first magnetic member 162 can be either a magnet or a metallic portion as long as the second magnetic member 164 is the complementary metallic portion or magnet. In one embodiment, both the first and second magnetic members 162, 164 are magnets.

FIG. 6 is a cross-sectional view of a pad coupler removably secured to a printing pad illustrating a magnetic interface, in accordance with one embodiment of the present invention. The first magnetic member 162 of the pad coupler 126 includes a magnet. The second magnetic member 164 of the printing pad 122 includes a metallic portion, such as a ferrous material, for example. The metallic portion can be a pin, such as a screw, bar, or the like, positioned within a flange portion 170 of the printing pad 122. Flange portion 170 is positioned in between flange portions 172, 174 of the pad coupler 126. The first and second magnetic members 162, 164 are positioned within molded apertures within the pad coupler 126 and printing pad 122, respectively. Alternatively, the magnet can be positioned within the printing pad 122 and the metallic portion positioned within the pad coupler 126. Those skilled in the art will recognize that the configuration of the first and second magnetic members 162, 164 may vary from the described embodiment and corresponding illustrations.

FIG. 7 is a cross-sectional view of a pad coupler removably secured to a printing pad illustrating a magnetic interface, in accordance with one embodiment of the present invention. The first magnetic member 162 of the pad coupler 126 includes a magnet. The second magnetic member 164 of the printing pad 122 includes a metallic portion. Metallic portion is a foil member positioned adjacent a surface portion 176 of the printing pad 122. The first magnetic member 162 is positioned within molded aperture within the pad coupler 126. Alternatively, the magnet can be positioned within the printing pad 122 and the metallic portion 180 positioned adjacent a surface portion of the pad coupler 126. Those skilled in the art will recognize that the configuration of the first and second magnetic members 162, 164 may vary from the described embodiment and corresponding illustrations.

It is important to note that the figures and description illustrate specific applications and embodiments of the present invention, and is not intended to limit the scope of the present disclosure or claims to that which is presented therein. While the figures and description present strategies for mounting a pad to a pad printer, the present invention is not limited to that format, and is therefore applicable to other formats. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A pad printer comprising:
a frame;
a pad coupler attached to the frame;
a printing pad; and
a locking mechanism;
wherein the locking mechanism removably secures the printing pad to the pad coupler.

2. The printer of claim 1 wherein the pad coupler has a first aperture and the printing pad has a second aperture, and the locking mechanism comprises a keeper removably disposed in the first aperture and the second aperture.

3. The printer of claim 2 wherein the keeper is a locking ring.

4. The printer of claim 2 wherein the keeper is a C-shaped clip.

5. The printer of claim 2 wherein the keeper is a pin.

6. The printer of claim 5 wherein surface features of the pin are selected from the group consisting of smooth, threaded, and ridged.

7. The printer of claim 1 wherein the locking mechanism comprises a pad interface.

8. The printer of claim 7 wherein:
the pad interface comprises at least one surface of the printing pad complementary to at least one surface of the pad coupler; and
the at least one surface of the printing pad interlocks with the at least one surface of the pad coupler.

9. The printer of claim 7 wherein the pad interface comprises a dovetail interface.

10. The printer of claim 7 wherein the pad interface comprises a flange interface.

11. The printer of claim 1 wherein the locking mechanism comprises a magnetic interface.

12. The printer of claim 11 wherein the magnetic interface comprises:
a first magnetic member in the pad coupler; and
a second magnetic member in the printing pad;
wherein the first and second magnetic members are magnetically attractive.

13. The printer of claim 12 wherein the first magnetic member comprises at least one of a magnet and a metallic portion.

14. The printer of claim 13 wherein the metallic portion is selected from a group consisting of foil and a pin.

15. The printer of claim 12 wherein the second magnetic member comprises at least one of a magnet and a metallic portion.

16. The printer of claims 15 wherein the metallic portion is selected from a group consisting of foil and a pin.

17. The printer of claim 12 wherein at least one of the first magnetic member and the second magnetic member is positioned within a molded aperture.

18. A mounting method comprising:
providing a frame having a pad coupler;
providing a printing pad; and
removably securing the printing pad to the pad coupler.

19. The method of claim 18 wherein the removably securing comprises removably securing the printing pad to the pad coupler with a locking mechanism selected from the group consisting of a pad interface, a magnetic interface, and a keeper removably disposed in a first aperture in the pad coupler and a second aperture in the printing pad.

20. A mounting system comprising:
a frame having a pad coupler;
a printing pad; and
means for removably securing the printing pad to the pad coupler.
